(19) United States
(12) Patent Application Publication
(10) Pub. No.: US 2015/0263391 A1
(43) Pub. Date: Sep. 17, 2015

(54) BATTERY PACK

(71) Applicant: Samsung SDI Co., Ltd., Yongin-si (KR)

(72) Inventor: Sung-Soo Choi, Yongin-si (KR)

(21) Appl. No.: 14/626,854

(22) Filed: Feb. 19, 2015

(30) Foreign Application Priority Data
Mar. 13, 2014 (KR) 10-2014-0029328

(51) Int. Cl. H01M 10/44; H01M 10/42; H02J 7/00

(52) U.S. Cl. CPC H01M 10/441; H02J 7/0026; H02J 7/0021; H02J 7/0052; H01M 10/425; H01M 2010/4271

(57) ABSTRACT

A battery pack, including a plurality of battery cells coupled in series, an analog front end integrated circuit (AFE IC) coupled in parallel to the plurality of battery cells, and a plurality of fuses coupled between the plurality of battery cells and the AFE IC, wherein, a terminal between adjacent fuses from among the plurality of fuses is coupled to a battery cell of the plurality of battery cells, and an other terminal between the adjacent fuses is coupled to the AFE IC.

### CROSS-REFERENCE TO RELATED APPLICATION

This application claims priority to and the benefit of Korean Patent Application No. 10-2014-0029328, filed on Mar. 13, 2014, in the Korean Intellectual Property Office, the entire content of which is incorporated herein by reference in its entirety.

### BACKGROUND

1. Field

An aspect of the present invention relates to a battery pack, and more particularly, to a battery pack having improved safety due to a protection circuit built therein.

2. Description of the Related Art

In general, studies on rechargeable batteries have been actively conducted with the development of portable electronic devices such as cellular phones, notebook computers, camcorders, and PDAs.

Particularly, various kinds of batteries such as a nickel-cadmium battery, a lead storage battery, a nickel metal hydride battery (NiMH), a lithium ion battery, a lithium polymer battery, a metal lithium battery and an air zinc storage battery are developed as secondary batteries. Such a battery is put together with a circuit, thereby constituting a battery pack, and the charging and discharging of the battery cell are performed through an external terminal of the battery pack.

A related art battery pack generally includes a battery cell, and a peripheral circuit or protection circuit including a charging/discharging circuit. The peripheral circuit is manufactured with a printed circuit board and then coupled to the battery cell. If an external power source is connected to the battery cell through an external terminal of the battery pack, the battery cell is charged by external power supplied through the external terminal and the charging/discharging circuit. If a load is connected to the battery cell through the external terminal of the battery pack, the power of the battery cell is supplied to the load through the charging/discharging circuit and the external terminal. In this case, the charging/discharging circuit controls the charging/discharging of the battery cell between the external terminal and the battery cell. Generally, the battery cell is used in tandem with a plurality of battery cells connected in series and/or parallel to be suitable for the consumption capacity of the load.

### SUMMARY

Aspects of embodiments of the present invention are directed toward a battery pack having improved safety due to a protection circuit built therein.

According to aspect of embodiments of the present invention, there is provided a battery pack, including: a plurality of battery cells coupled in series; an analog front end integrated circuit (AFE IC) coupled in parallel to the plurality of battery cells; and a plurality of fuses coupled between the plurality of battery cells and the AFE IC, wherein, a terminal between adjacent fuses from among the plurality of fuses is coupled to a battery cell of the plurality of battery cells, and an other terminal between the adjacent fuses is coupled to the AFE IC.

The AFE IC may sense at least one of a temperature of each of the battery cells, a charging voltage of each of the battery cells, and an amount of current flowing into each of the battery cells.

The plurality of fuses may be arranged between the plurality of battery cells and the AFE IC along a direction substantially perpendicular to a direction of series connection of the plurality of battery cells.

One of the adjacent fuses may be located adjacent to the battery cell, and an other of the adjacent fuses may be located adjacent to the AFE IC.

The plurality of fuses may be between the plurality of battery cells and the AFE IC along a direction substantially parallel to a direction of series connection of the plurality of battery cells.

The battery pack may further include a microcomputer configured to detect when the AFE IC is in an abnormal state.

The battery pack may further include a mechanism including a control switch and a heater and configured to blow the fuse.

The microcomputer may be configured to control the fuse to be blown by outputting a control signal to the control switch when the microcontroller detects that the AFE IC is in the abnormal state.

The AFE IC may be configured to transmit the sensed charging voltage to the microcomputer.

The battery pack may further include a charging element and a discharging element coupled in series on a high current path between an external terminal and the plurality of battery cells to perform charging and discharging of the plurality of battery cells.

The microcomputer may be configured to control the charging element to stop the charging of the plurality of battery cells when the voltage of the plurality of battery cells is no less than an overcharging level voltage value, and wherein the microcomputer may be configured to control the discharging element to stop the discharging of the plurality of battery cells when the voltage of the plurality of battery cells is no more than an overdischarging level voltage value.

According to some embodiments of the present invention, it is possible to improve the safety of the protection circuit built in the battery pack.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a circuit diagram of a related art battery pack.

FIG. 2 is a diagram showing a connection relationship between battery cells and an analog front end integrated circuit (AFE IC), according to an example embodiment of the present invention.

FIG. 3 is a diagram showing a connection relationship between the battery cells and the AFE IC, according to another example embodiment of the present invention.

FIG. 4 is a diagram showing a connection relationship between the battery cells and the AFE IC, according to still another example embodiment of the present invention.

FIG. 5 is a diagram showing a connection relationship between the battery cells and the AFE IC, according to still another example embodiment of the present invention.

### DETAILED DESCRIPTION

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “coupled to” or “connected to” another element, it can be directly connected to the another element or be indirectly connected to the another element with one or more intervening elements interposed therebetween. Hereinafter, like reference numerals refer to like elements.

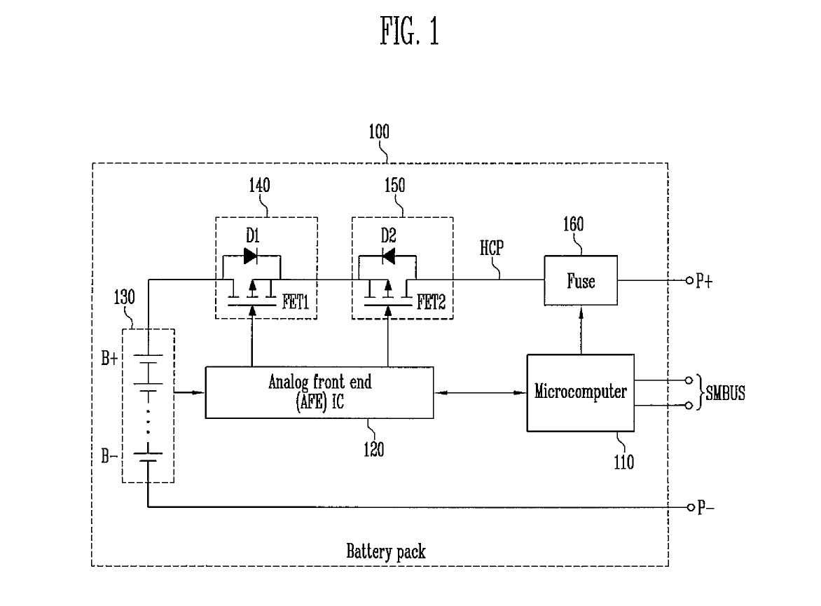

FIG. 1 is a circuit diagram of a related art battery pack.

Referring to FIG. 1, the related art battery pack 100 includes a rechargeable battery cell 130 and a protection circuit. For example, the battery pack 100 is mounted in an external system such as a portable notebook computer to perform charging of the battery cell 130 and discharging from the battery cell 130.

The battery pack 100 includes the battery cell 130, an eternal terminal electrically coupled in parallel (e.g., connected in parallel) to the battery cell 130, charging and discharging elements 140 and 150 electrically coupled in series (e.g., connected in series) to a high current path (HCP) between the battery cell 130 and the external terminal, a fuse 160 electrically coupled in series to an HCP between the discharging element 150 and the external terminal, an analog front end integrated circuit (AFE IC) 120 coupled (e.g., connected) in parallel to the battery cell 130 and the charging and discharging elements 140 and 150, and the protection circuit configured to include a microcomputer 110 of which one end (e.g., the other end) is coupled to the fuse 160. The battery pack 100 may further include a self-protection control device configured to blow the fuse 160 under the control of the microcomputer 110 or the external system.

When determining (e.g., deciding) that the battery cell 130 is in an overcharging or overdischarging state, the microcomputer 110 blocks (or prevents further) overcharging or overdischarging of the battery cell 130 by turning off the charging or discharging element 140 or 150 or by blowing the fuse 160. For example, when deciding (e.g., after determining) that the battery cell 130 is in an overcharging or overdischarging state, the microcomputer 110 outputs a control signal corresponding to the overcharging or overdischarging state of the battery cell 130, to blow the fuse 160 through a control switch and a heater.

When deciding (e.g., after determining) that the AFE IC 120 is in an abnormal state, the microcomputer 110 may output a control signal corresponding to the abnormal state of the AFE IC 120, to blow a fuse provided on a HCP between the AFE IC 120 and the battery cell 130 through the control switch and the heater.

The battery pack 100 configured as described above may be charged or discharged by being electrically coupled to the external system through the external terminal. The HCP between the external terminal and the battery cell 130 is used as a charging/discharging path, and high current flows through the HCP. The battery pack 100 further includes a system management BUS (SMBUS) between the microcomputer 110 of the protection circuit and the external terminal in order to communicate with the external system.

In one embodiment, the external system electrically coupled to the battery pack 100 through the external terminal may include an adaptor configured to separately supply power to a portable electronic device, e.g., a portable notebook computer. Accordingly, when the external system is electrically coupled to the adaptor, the external system may be operated by the adaptor, and the power of the adaptor may charge the battery cell 130 by being supplied to the battery cell 130 via the HCP through the external terminal. When the external system is separated from (e.g., electrically disconnected from) the adaptor, the battery cell 130 may be discharged to a load of the external system through the external terminal. When the external system having the adaptor electrically coupled thereto is coupled to the external terminal, a charging operation is performed. In this case, the charging path is continued from the adaptor to the battery cell 130 via the external terminal, the discharging element 150 and the charging element 140. When the adaptor is separated from (e.g., electrically disconnected from) the external system, and the load of the external system is electrically coupled to the external terminal, a discharging operation is performed. In this case, the discharging path is continued from the battery cell 130 to the load of the external system via the charging element 140, the discharging element 150, and the external terminal.

In one embodiment, the battery cell 130 is a secondary battery cell that may be charged and discharged. In FIG. 1, B+ and B− represent a high current terminal and show both ends of battery cells electrically coupled in series (e.g., connected in series). The battery cell 130 outputs, to the AFE IC 120, various suitable information, for example, information on the temperature of the battery cell, the charging voltage of the battery cell, the amount of current flowing in the battery cell, and/or the like.

The charging and discharging elements 140 and 150 are coupled in series to each other on the HCP between the external terminal and the battery cell 130, to perform charging or discharging of the battery pack. Each of the charging and discharging elements 140 and 150 may include (e.g., be configured with) a field effect transistor (FET).

The AFE IC 120 detects a voltage of the battery cell 130 and transmits the detected voltage to the microcomputer 110. The AFE IC 120 controls operations of the charging and discharging elements 140 and 150 under the control of the microcomputer 110.

The microcomputer 110 is an integrated circuit coupled in series between the AFE IC 120 and the external system. The microcomputer 110 controls the charging and discharging elements 140 and 150 through the AFE IC 120 to block (e.g., to prevent or to stem) overcharging or overdischarging of the battery cell 130 and block an overcurrent condition from occurring at the battery cell 130. For example, the microcomputer 110 turns on or turns off the charging and discharging elements 140 and 150 by comparing the voltage of the battery cell 130, received from the battery cell 130 through the AFE IC 120, with a voltage level value set (e.g., preset or pre-programmed) inside the microcomputer 110, and outputting a control signal based on the compared result to the AFE IC 120. Accordingly, it is possible to block the overcharging and overdischarging of the battery cell 130.

For example, when the voltage of the battery cell 130, received by the microcomputer 110, is no less than an overcharging level voltage value set inside the battery cell 130, e.g., 4.35V, the microcomputer 110 decides (e.g., determines) that the battery cell 130 is in an overcharging state, and outputs, to the AFE IC 120, a control signal corresponding to the overcharging state of the battery cell 130, thereby turning off a field effect transistor FET1 of the charging element 140. Then, the charging from the adaptor of the external system to the battery cell 130 is blocked. On the contrary, when the voltage of the battery cell 130, received by the microcomputer 110, is no more than an overdischarging level voltage value set inside the battery cell 130, e.g., 2.30V, the microcomputer 110 decides (e.g., determines) that the battery cell 130 is in an overdischarging state, and outputs, to the AFE IC 120, a control signal corresponding to the overdischarging state of the battery cell 130, thereby turning off a field effect transistor FET2 of the discharging element 150. Then, the discharging from the battery cell 130 to the load of the external system is blocked. Here, it has been described that the AFE IC 120 controls the switching operation of the charging or discharging element 140 or 150 under the control of the microcomputer 110. However, the microcomputer 110 may directly control the switching operation of the charging or discharging element 140 or 150.

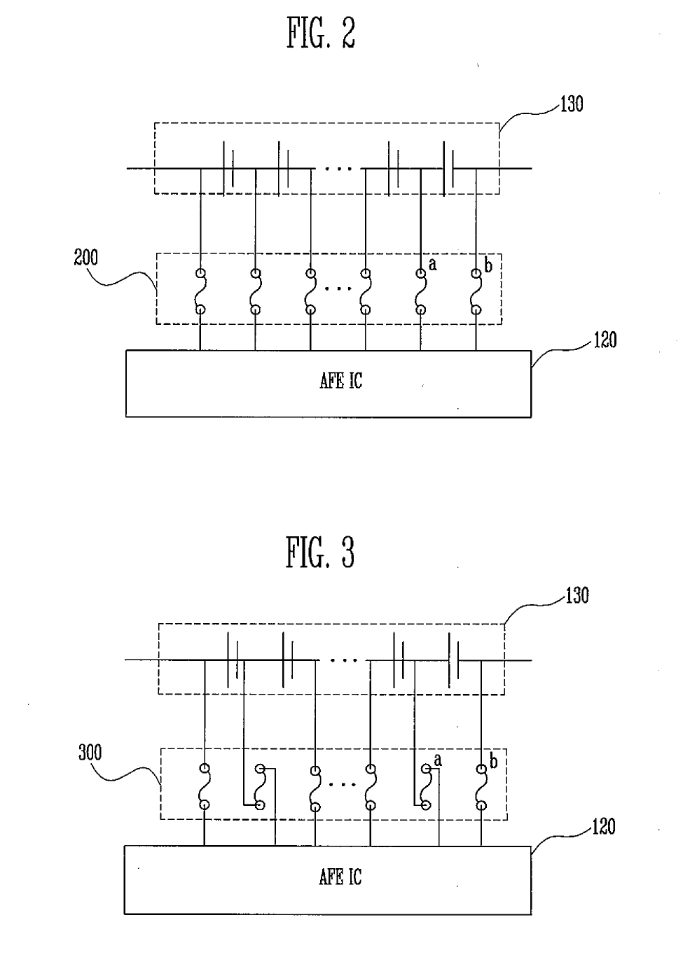

FIG. 2 is a diagram showing a connection relationship between battery cells and an AFE IC, according to an example embodiment of the present invention.

Referring to FIG. 2, the AFE IC 120 and the battery cells 130 are electrically coupled to each other via the fuses 200. The fuses 200 are longitudinally arranged (e.g., arranged along a direction substantially perpendicular to a direction of series connection of the battery cells 130) on corresponding paths between the plurality of battery cells 130 and the AFE IC 120 in order to prevent a short circuit of the battery cell 130, caused by a failure of the AFE IC 120.

When a and b that are terminals between fuses adjacent to each other are short circuited by a conductor such as a foreign material, the battery cell 130 is also short-circuited, and therefore, a safety problem may occur. In order to prevent such a problem, a silicon for short-circuit prevention may be applied to the terminals of the fuse 200. However, the addition of this process may lead to additional manufacturing cost.

FIG. 3 is a diagram showing a connection relationship between the battery cells and the AFE IC, according to another example embodiment of the present invention.

Referring to FIG. 3, the AFE IC 120 and the battery cells 130 included in (e.g., built in) the battery pack, according to an embodiment of the present invention, are electrically coupled to each other via the fuses 200. The fuses 300 are longitudinally arranged (e.g., arranged along a direction substantially perpendicular to a direction of series connection of the battery cells 130) on corresponding paths between the plurality of battery cells 130 and the AFE IC 120.

In one embodiment, among a and b that are terminals between adjacent fuses of the plurality of fuses 300, the terminal a is electrically coupled to the battery cell 130, and the terminal b is electrically coupled to the AFE IC 120. Thus, when the terminals a and b, which are electrically coupled to different polarities from each other, are short-circuited by a conductive material, only the fuse 300 is blown, and the battery cell 130 does not short-circuit. Accordingly, although a separate silicon for short-circuit prevention is not applied to the terminal of the fuse 300, it may be possible to improve the safety of a protection circuit included in the battery pack. Further, it may be possible to omit a separate process (e.g., manufacturing process) which presents additional cost.

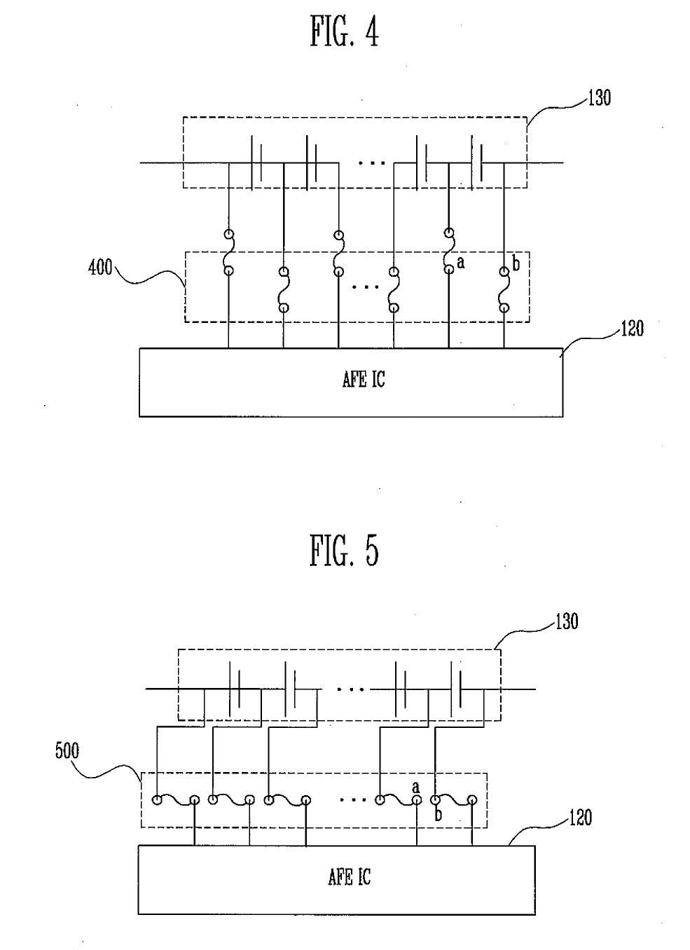

FIG. 4 is a diagram showing a connection relationship between the battery cells and the AFE IC, according to still another example embodiment of the present invention.

Referring to FIG. 4, the AFE IC 120 and the battery cells 130, built in the battery pack, according to an embodiment of the present invention, are coupled to each other via the fuses 200. The fuses 400 are longitudinally arranged (e.g., arranged along a direction substantially perpendicular to a direction of series connection of the battery cells 130) on corresponding paths between the plurality of battery cells 130 and the AFE IC 120.

In an embodiment, one of terminals between adjacent fuses among the plurality of fuses 400 is located (e.g., positioned or disposed) adjacent to the battery cell 130, and another terminal is located adjacent to the AFE IC 120.

Through the disposition described above, among a and b that are terminals between adjacent fuses of the plurality of fuses 400, the terminal a is electrically coupled to the AFE IC 120, and the terminal b is electrically coupled to the battery cell 130. Thus, when the terminals a and b electrically coupled to different polarities from each other are short-circuited by a conductive material, only the fuse 400 is blown, and the short-circuit of the battery cell 130 does not occur.

FIG. 5 is a diagram showing a connection relationship between the battery cells and the AFE IC 120, according to still another example embodiment of the present invention.

Referring to FIG. 5, the AFE IC 120 and the battery cells 130, built in the battery pack, according to an embodiment of the present invention, are electrically coupled to each other via the fuses 200. The fuses 500 are laterally arranged (e.g., arranged along a direction substantially parallel to a direction of series connection of the battery cells 130) on corresponding paths between the plurality of battery cells 130 and the AFE IC 120.

As the fuses 500 are laterally arranged, among a and b that are terminals between adjacent fuses of the plurality of fuses 400, the terminal a is electrically coupled to the AFE IC 120, and the terminal b is electrically coupled to the battery cell 130. Thus, when the terminals a and b electrically coupled to different polarities from each other are short-circuited by a conductive material, only the fuse 500 is blown, and the short-circuit of the battery cell 130 does not occur.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various suitable changes in form and details may be made without departing from the spirit and scope of the present invention as set forth in the following claims and equivalents thereof.

What is claimed is:

1. A battery pack, comprising:
a plurality of battery cells coupled in series;
an analog front end integrated circuit (AFE IC) coupled in parallel to the plurality of battery cells; and
a plurality of fuses coupled between the plurality of battery cells and the AFE IC,
wherein, a terminal between adjacent fuses from among the plurality of fuses is coupled to a battery cell of the plurality of battery cells, and an other terminal between the adjacent fuses is coupled to the AFE IC.

2. The battery pack of claim 1, wherein the AFE IC senses at least one of a temperature of each of the battery cells, a charging voltage of each of the battery cells, and an amount of current flowing into each of the battery cells.

3. The battery pack of claim 1, wherein the plurality of fuses are arranged between the plurality of battery cells and the AFE IC along a direction substantially perpendicular to a direction of series connection of the plurality of battery cells.

4. The battery pack of claim 3, wherein, one of the adjacent fuses is located adjacent to the battery cell, and an other of the adjacent fuses is located adjacent to the AFE IC.

5. The battery pack of claim 1, wherein the plurality of fuses are between the plurality of battery cells and the AFE IC along a direction substantially parallel to a direction of series connection of the plurality of battery cells.

6. The battery pack of claim 2, further comprising a microcomputer configured to detect when the AFE IC is in an abnormal state.

7. The battery pack of claim 6, further comprising a mechanism comprising a control switch and a heater and configured to blow the fuse.

8. The battery pack of claim 7, wherein the microcomputer is configured to control the fuse to be blown by outputting a control signal to the control switch when the microcontroller detects that the AFE IC is in the abnormal state.

9. The battery pack of claim 6, wherein the AFE IC is configured to transmit the sensed charging voltage to the microcomputer.

10. The battery pack of claim 9, further comprising a charging element and a discharging element coupled in series on a high current path between an external terminal and the plurality of battery cells to perform charging and discharging of the plurality of battery cells.

11. The battery pack of claim 10, wherein the microcomputer is configured to control the charging element to stop the charging of the plurality of battery cells when the voltage of the plurality of battery cells is no less than an overcharging level voltage value, and
wherein the microcomputer is configured to control the discharging element to stop the discharging of the plurality of battery cells when the voltage of the plurality of battery cells is no more than an overdischarging level voltage value.
